(19) United States
(12) Patent Application Publication
(10) Pub. No.: US 2018/0248712 A1
(43) Pub. Date: Aug. 30, 2018

(54) METHOD FOR ASSURING OPERATION OF A WIRELESS MODULE OF A FIELD DEVICE

(71) Applicant: ENDRESS+HAUSER GMBH+CO. KR, Maulburg (DE)

(72) Inventors: Christian Seiler, Neuenburg (DE); Peter Klöfer, Steinen (DE)

(21) Appl. No.: 15/758,375

(22) PCT Filed: Aug. 12, 2016
(86) PCT No.: PCT/EP2016/069198

§ 371 Date: Mar. 8, 2018

(30) Foreign Application Priority Data
Sep. 10, 2015 (DE) 10 2015 115 274.6

(51) Int. Cl. H04L 12/40; H04L 12/10; H04W 84/18; H02J 1/14

(52) U.S. Cl. CPC H04L 12/40039; H04L 12/10; H04L 12/40045; H04L 2012/4026; H02J 1/14; H04L 2012/40221; H04W 84/18

(57) ABSTRACT

The invention relates to a method for assuring operation of a wireless module of a process automation field device having the wireless module and at least one function module, wherein the field device is supplied with energy by a two conductor bus, wherein the wireless module is continuously supplied with energy by the two conductor bus, wherein the wireless module is placed in a test mode, in which the wireless module transmits with maximum transmission power and is supplied further by the two conductor bus continuously with energy, and wherein the function module then so adjusts its operation that the maximum energy available to the field device is not exceeded.

The invention relates to a method for assuring operation of a wireless module of a field device of process automation, wherein the field device includes the wireless module and at least one function module.

In process automation technology, field devices are often applied, which serve for registering and/or influencing process variables. Referred to as field devices are, in principle, all devices, which are applied near to the process and which deliver, or process, process relevant information. Besides sensors and actuators, referred to as a field devices are generally also such units, which are connected directly to a fieldbus, and which serve for communication with a control unit such as a control system, i.e. units such as e.g. remote I/Os, gateways, linking devices and wireless adapters.

A large number of such field devices are produced and sold by the Endress+Hauser group of companies.

Frequently, field devices are connected to a control station by means of two wire technology. In the case of two wire technology, also called two conductor technology, electrical current for energy supply and communication signals are sent via the same line: one wire for the outgoing direction and one wire for the return path. In other words, power supply and signal utilize the same line; there is no separate energy supply. This electrical current, and the corresponding power, must be managed by the field devices and divided out to the individual components of the field device. Thus, for instance, the sensor element, the communication and the control unit must together manage within the present power budget.

The rejection of wired data transmission for connecting a field device has in the field of industry the potential to reduce costs of wiring, improve usability and therewith generate benefits for the user.

Due to the availability of very energy saving components and standards for wireless communication, an option is to use radio technologies also in two conductor measuring devices, without having to use further energy storers, such as e.g. specially provided capacitors. It is possible to implement both the measuring function as well as also the wireless transmission in parallel.

There are measuring methods, which need an energy storer in the form an energy storing capacitor, since the provided power is not sufficient for the measuring, so that energy must be collected between the measurements. An example of this is fill level measurement according to the radar principle. If there is added to a corresponding measuring device an energy saving wireless interface, no further energy storer is required in the system, when the measuring system is supplied exclusively from the already present energy storing capacitor. The measuring is, in this case, only performed, when the energy storing capacitor has a sufficient capacitance. The duration of the period between the individual measurements depends then on how much power exactly is required by the wireless interface and additional function modules in the system. Excess power is stored in the corresponding energy storing capacitor.

U.S. Pat. No. 7,262,693, for example, discloses the application of a capacitor, in order to store energy from the bus intermediately, in order then to provide it to a wireless module.

Depending on power consumption of the measuring function, however, an exactly simultaneous operation of the measuring and radio transmission is frequently not possible. Then it is e.g. required to perform the measuring and radio transmission alternately, in order to be able to manage further without energy storage in the system.

It is, thus, unclear, whether a measuring device in a plant can be operated with the available supply voltage in each case safely with a defined behavior, for instance, a certain measuring rate, since the energetic influence of the radio communication cannot be ascertained. This holds especially for devices, whose radio interface is supplied completely from the two wire interface without an additional energy storer.

An object of the invention is to detect, whether a wireless module in a field device supplied by a two conductor bus always has sufficient energy available.

The object is achieved by a method with a field device having a wireless module and at least one function module, wherein the field device is supplied with energy by a two conductor bus, wherein the wireless module is continuously supplied with energy by the two conductor bus, wherein the wireless module is placed in a test mode, in which the wireless module transmits with maximum transmission power and is supplied further by the two conductor bus continuously with energy, and wherein the function module then so adjusts its operation that maximum energy available to the field device is not exceeded.

The user can then test, which maximum operating parameters in the case of maximum power consumption of the wireless module are still possible with the terminal voltage provided to the field device. Thus, the influence of the wireless communication on the actual functioning of the function module in applications of the user can be confirmed.

By this method, a terminal voltage can be ascertained, in the case of which the function module can exactly no longer function, since the entire power has been provided to the wireless module. Or, conversely, operating parameters can be so adapted that operation of the function module is exactly still possible.

Furthermore, the test mode facilitates an analysis of the bandwidth used by the field device in the free frequency band. Use of the test mode increases the data traffic and therewith use of the frequency band as a function of time. Corresponding analytical devices can thereby better detect and visualize the radio signals of the field device than when these, such as in many cases of application, occupy the spectrum only very shortly and sporadically.

Furthermore, the test mode can be utilized for range testing and for orientation of the radio antenna of the field device.

In an advantageous, further development, the wireless module includes no energy storer and is continuously and exclusively supplied with energy by the two conductor bus. Thus, this module can always and durably be fully functionally able.

Preferably, after its activation, the test mode is deactivated principally by manual input. Thus, the user is not rushed during the testing of the wireless module. It is so also assured that the wireless module is supplied continuously and exclusively by the two conductor bus. As has been mentioned, in an embodiment, there is no energy storer associated with the wireless module.

In an advantageous embodiment, the test mode is activated by button press on the field device, via interaction with a display of the field device, via a servicing device, which is connected with the field device wirelessly or directly by wire, or via a servicing device, which is connected with the field device via the two conductor bus.

For assuring that only a minimum input energy is available to the wireless module at maximum consumption when the field device is in test mode, a smallest possible electrical current input, especially, for instance, 3.6 mA, is set on the two conductor bus.

In an additional preferred embodiment, the wireless module transmits in the test mode with highest data rate, maximum power, maximum range, maximally widest frequency band, continuous transmission operation by means of continuous carrier and/or maximum power consuming radiation angle.

In a preferred form of embodiment, a change of the input voltage of the field device, especially the supply voltage on the two conductor bus, influences the operation of the function module. If a user, for example, increases the input voltage supplied to the field device, then this is exclusively to the advantage of the function module, since the excess power cannot be taken up by the wireless module (it is already consuming maximum power). The excess power can then, for instance, be collected in an additional energy storer.

In an advantageous, further development, the function module consumes at least temporarily more energy than the two conductor bus continuously delivers, and an energy storer loaded by the two conductor bus is associated with the function module.

In an additional preferred embodiment, the function module sends its operating parameters matched to the maximum energy available to the field device and/or its maximum possible operating parameters to a display of the field device via communication via the two conductor bus and/or via the wireless module.

In an advantageous form of embodiment, the function module includes a sensor element for registering a measured variable, wherein the sensor element forwards values to a wireless module, and wherein the wireless module is embodied for wirelessly transmitting the values to a superordinated unit.

The terminology, “values”, in the sense of this invention, means in a first advantageous embodiment “values dependent on the measured variable”. I.e., the sensor element forwards to the wireless module values dependent on the measured variable, and the wireless module transmits the values dependent on the measured variable wirelessly to a superordinated unit.

In a second advantageous embodiment, the terminology, “values”, means parameters, wherein a “parameter”, in such case, is an actuating- or influencing variable, which acts on the sensor element and, thus, changes the behavior of the sensor element or delivers information concerning the state of the sensor element. I.e., the sensor element forwards parameters to the wireless module, wherein the wireless module wirelessly transmits these parameters to a superordinated unit. In an additional advantageous, further development, parameters are transmitted in the reverse direction, i.e. a superordinated unit transmits parameters wirelessly to the wireless module, which forwards the parameters to the sensor element.

In an advantageous embodiment, the first module includes, thus, a sensor element, for instance, for registering fill level, for example, according to the radar principle. In an additional embodiment, the first module includes a sensor element (e.g. ISFET) for determining an analytical parameter, especially for measuring pH, redox-potential conductivity, turbidity or oxygen. Other advantageous embodiments comprise sensor elements for registering flow according to one of the principles, Coriolis, magneto-inductive, vortex and ultrasound. Other advantageous embodiments comprise sensor elements for registering fill level according to one of the principles, guided and freely radiating radar (such as already mentioned), as well as ultrasound, also for detecting a limit level, wherein for detecting limit level also capacitive methods can be used.

The invention will now be explained in greater detail based on the appended drawing, the figures of which show as follows:

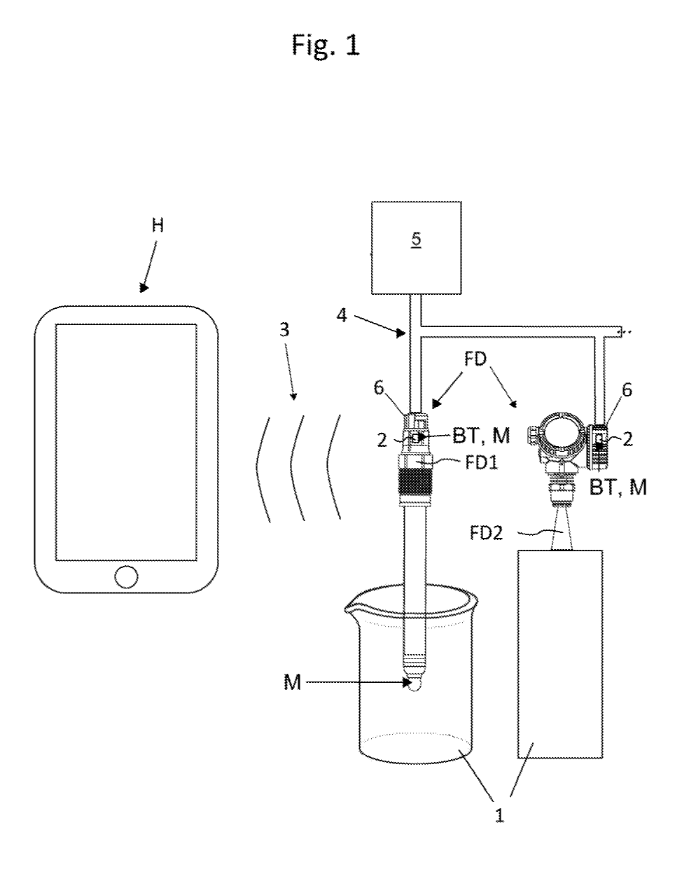

FIG. 1 a field device, in which methods of the invention are applied,

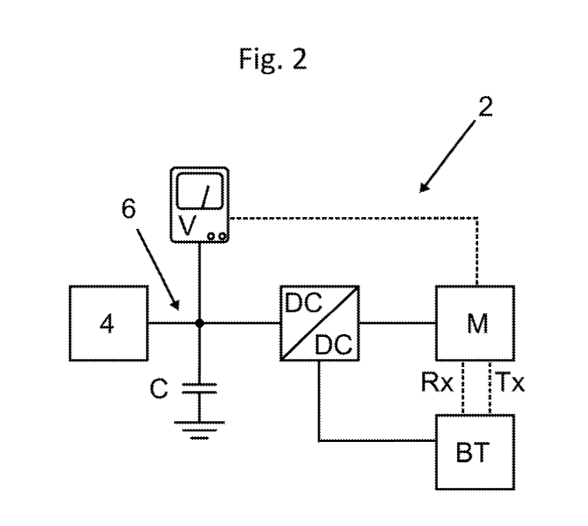

FIG. 2 an electronic circuit in the field device, comprising a wireless module and a function module, and

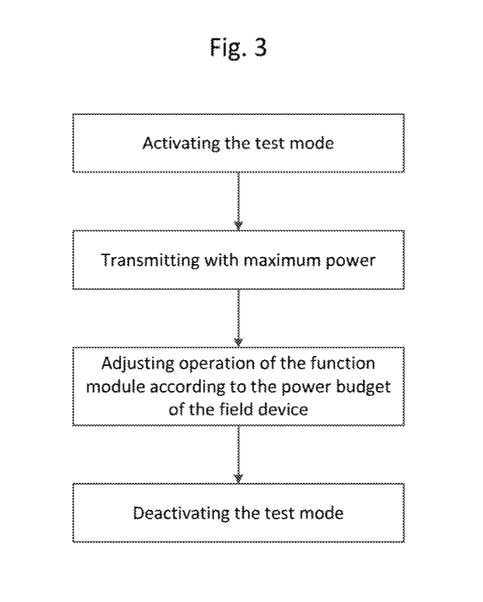

FIG. 3 the method of the invention illustrated in the form of a flow diagram.

In the figures, equal features are provided with equal reference characters.

FIG. 1 shows a field device FD of process automation technology, for example, a sensor. More exactly, two field devices FD1 and FD2 are pictured. The sensor is, for instance, a pH-, redox-potential-, also ISFET-, conductivity-, turbidity- or oxygen sensor. Other possible sensors are flow sensors according to the principles, Coriolis, magneto-inductive, vortex and ultrasound. Other possible sensors are sensors for measuring the fill level according to the principles, guided and freely radiating radar as well as ultrasound, also for detecting a limit level, wherein for detecting limit level also capacitive methods can be used. The sensor includes a sensor element M as a first function module of the field device FD. Also, the sensor element M can be part of the electronic circuit 2, see below.

Shown on the left is a pH sensor and on the right a fill-level sensor working according to the radar principle. The field device FD determines a measured variable of a medium 1, in the example present in a beaker, such as shown on the left side. Equally possible are other containments, such as conduits, vats (such as shown on the right side), containers, kettles, pipes, pipelines and the like.

The field device FD communicates with a control unit, for instance, directly with a control system 5 or with an interposed transmitter. Also, the transmitter can be part of the field device, such as, for instance, in the case of the level sensor. The communication to the control system 5 occurs via a two conductor bus 4 operating, for instance, via a HART, PROFIBUS PA or FOUNDATION Fieldbus protocol. It is also possible to embody the interface 6 to the bus supplementally or alternatively as a wireless interface, for instance, according to the wireless HART standard (not shown), wherein via wireless HART a connection directly to a control system occurs via a gateway. Moreover, optionally or supplementally, in the case of the HART protocol, a 4.20 mA interface is provided (not shown). If the communication occurs supplementally or alternatively to a transmitter, instead, directly to the control system 5, either the above mentioned bus systems (HART, PROFIBUS PA or FOUNDATION Fieldbus) can be used for communication, or, for example, a proprietary protocol, for instance, of type “Memosens” is used. Corresponding field devices, such as above described, are sold by the applicant.

As mentioned, an interface 6 is provided on the bus side of the field device FD for connection to the two conductor bus 4. Shown is a wired variant for connecting to the bus by means of the interface 6. Interface 6 is, for example, embodied as a galvanically isolating, especially as an inductive, interface. This is shown in the case of the pH sensor. Interface 6 is composed of two parts, with a first part located on the field device side and a second part on the bus side. These can be coupled with one another by means of a mechanically plugged connection. Sent via the interface 6 are data (bidirectionally) and energy (unidirectionally, i.e. in the direction from the control unit 5 to the field device FD). Alternatively, an appropriate cable is used with or without galvanic isolation. Possible embodiments comprise a cable with an M12- or ⅞″ plug. This is shown, for example, in the case of the fill-level measuring device operating according to the radar principle.

Field device FD further includes an electronic circuit 2 comprising a wireless module BT for wireless communication 3. The wireless module BT is a second function module of the field device FD. The wireless communication 3 does not serve for connecting to the two conductor bus 4.

The wireless module BT is, for instance, embodied as a Bluetooth module. The Bluetooth module forms especially to the protocol stack, Low Energy, e.g. “Bluetooth Low Energy” (also known as BTLE, BLE, or Bluetooth Smart). In given cases, the wireless module BT includes a corresponding circuit, or components. The field device FD conforms, thus, at least to the standard, “Bluetooth 4.0”. The communication 3 occurs from the field device FD to a superordinated unit H. The superordinated unit H is, for example, a mobile unit, such as a mobile telephone, a tablet, a notebook, or the like. Alternatively, the superordinated unit H can also be embodied as a nonportable device, such as, for instance, a computer. Alternatively, the superordinated unit is a display with corresponding interface.

FIG. 2 shows the electronic circuit more exactly. The circuit 2 includes as a function module the sensor element M and as a second module the wireless module BT. Each of the modules is supplied with energy by the bus 4. Interposed in front of the two modules is a direct voltage converter DC (a DC-DC converter), wherein an energy storer C (see below) is placed in front of the direct voltage converter. The direct voltage converter DC converts the input voltage, for instance, 10-45 V, to, for instance, 3-5 V. In an alternative embodiment (not shown), the energy storer C is connected after the direct voltage converter DC.

Sensor element M serves for registering the measured variable. The two conductor bus 4 does not deliver enough energy, such that the sensor element M could be supplied with energy continuously by the two conductor bus 4, because of which an energy storer C is associated with the sensor element M. The energy storer C, thus, supplies the sensor element M with energy.

The energy storer C is, for instance, a capacitor for storing energy. In the sense of this invention, an energy storer is not a filter capacitor, a smoothing capacitor, a capacitor for assuring electromagnetic compatibility or a capacitor such as, for instance, required in direct voltage converters. The energy storer C is directly chargeable by the two conductor bus 4.

As mentioned, the sensor element M is supplied with energy via the energy storer C, since the energy requirement is greater than the two conductor bus 4 could continuously deliver. Generally, the sensor element M is a module, which temporarily requires a large power, or energy. This energy cannot be continuously delivered by the two conductor bus. Alternatively to the sensor element M, a wireless module with an increased energy requirement can be selected, for instance, a WLAN module. If, instead of the sensor element with high energy requirement, a WLAN module is used, instead of the wireless module BT (see below), a sensor element can be used, which can be supplied continuously by the bus 4, for instance, a temperature- or pressure sensor (see likewise below).

Circuit 2 further includes a wireless module BT for wireless transmission to the superordinated unit H of the values dependent on the measured variable. The wireless module is also supplied by the direct voltage converter DC, which converts the voltage, for instance, from 10-45 V to 3-5 V. It can, in such case, be the same direct voltage converter DC, which also delivers the energy for the sensor element M (shown), or it can be a separate direct voltage converter (not shown) or a linear converter (likewise not shown).

The wireless module BT is supplied with energy exclusively by the two conductor bus 4. The wireless module BT never needs more power than the two conductor bus 4 can continuously deliver. For this reason, also no additional capacitor, in general, no further energy storer, is necessary in this branch. The wireless module BT includes as a second function module, thus, no energy storer and is continuously and exclusively supplied by the two conductor bus 4.

In an alternative to the above mentioned wireless module BT, a sensor element, for instance, a temperature- or pressure sensor, can be used, which can be supplied continuously with energy by the bus 4.

Since the sensor element M consumes more energy than the bus 4 can continuously deliver, a measurement only takes place when the energy storer C is sufficiently charged and a complete measuring cycle can occur. In this regard, the circuit 2 also includes a corresponding measurement circuit V, in order to monitor the charge status of the energy storer C. After measurement of the corresponding measured variable, the sensor element M forwards values dependent on the measured variable to the wireless module BT. In this regard, communication lines Tx and Rx are used. This communication is shown dashed in FIG. 2.

Besides the values dependent on the measured variable, also parameters are transmitted, wherein the terminology, “parameter”, means an actuating- or influencing variable, which acts on the sensor element and, thus, changes the behavior of the sensor element or delivers information concerning the state of the sensor element. For the sake of completeness, it should be mentioned that parameters can also be transmitted in the reverse direction, i.e. a superordinated unit transmits parameters wirelessly to the wireless module, which forwards the parameters to the sensor element.

In order to detect whether the wireless module BT is always supplied with sufficient energy by the two conductor bus 4, the method of the invention illustrated in FIG. 3 by way of a flow diagram is provided and will now be explained.

First, a test mode is activated for the wireless module BT. In such case, the wireless module BT transmits with maximum transmission power and is, in such case, further supplied continuously with energy by the two conductor bus 4. The test mode is activated by button press on the field device FD, via interaction with a display of the field device FD, via the superordinated unit H, which is connected wirelessly (such as shown) or by wire (not shown, for instance, via an interposed transmitter) directly with the field device FD, or via a servicing device (thus, for instance, in the control system 5), which is connected with the field device FD via the two conductor bus 4. The test mode is deactivated after its activation only by manual input.

In the test mode, the wireless module BT transmits, such as mentioned, with maximum transmission power, i.e. with highest data rate, maximum range, maximum widest frequency band, continuous transmission operation by means of continuous carrier and/or maximum energy consuming radiation angle. At the same time, in the field device FD in the test mode, the smallest possible input electrical current is placed on the two conductor bus 4, thus especially, for instance, 3.6 mA. It is so assured that the wireless module BT consumes maximum energy for minimum energy input. The power used in the case of the test mode is completely drawable from the two conductor bus 4. Its delivered power is not exceeded, since additional energy storers are not present in the system for support of the wireless module BT.

If a user increases the input voltage (corresponding to the terminal voltage on the two conductor bus 4) to the field device FD, then this is exclusively to the advantage of the function module, thus the sensor element M, since the excess power is collected in the energy storing capacitor C.

The user can then test, which maximum operating parameters are still possible in the case of a minimum loop current of, for instance, 3.6 mA and maximum power consumption of the wireless module BT with the terminal voltage provided to the field device FD. Thus, the influence of the wireless communication on the actual measuring function can be confirmed for applications of the user. The terminology, “operating parameters”, means, in such case, parameters, which are important for the operation of the sensor element M, thus, for instance, the measuring rate, accuracy of measurement, resolution, mathematical operations such as averaging, filtering etc. These operating parameters are sent by the function module, thus, concretely, by the sensor element M, to a display of the field device FD via communication via the two conductor bus 4 and/or via the wireless module BT. The sensor element M fits the operating parameters to the maximum energy available to the field device FD. Also, the maximum operating parameters, i.e. the operating parameters, in the case of which operation can still just be maintained, can be correspondingly transmitted.

By this method, a terminal voltage can be ascertained, in the case of which, exactly, measuring is no longer possible, since the entire power has been provided to the wireless module BT. Or, in other words, operating parameters (for instance, a certain measuring rate) can be so adapted that operation of the sensor element M is just still possible.

Furthermore, the test mode facilitates an analysis of the bandwidth used by the field device in the free frequency band, for instance, in the ISM-band at, for example, 2.4 GHz or 5 GHz. The test mode increases the data traffic and therewith use of the frequency band as a function of time. Corresponding analytical devices can thereby better detect and visualize the radio signals of the field device FD than when these, such as in many cases of application, occupy the spectrum only very shortly and sporadically.

Furthermore, the test mode can be utilized for range testing and for orientation of the radio antenna of the field device FD.

In the above mentioned alternative, in which, instead of a wireless module BT, a sensor element, which can be supplied continuously by the bus 4, for instance, a temperature- or pressure sensor, is used, instead of the sensor element M, a wireless interface is used, which cannot be supplied continuously by the bus 4. The energy storer C is then associated with this interface. It can in this configuration be ascertained what the maximum transmission power, sending speed, sending rate, etc. of this wireless interface would be in the case of maximum consumption of the sensor element.

### LIST OF REFERENCE CHARACTERS

1 containment with medium to be measured

2 electronic circuit

3 wireless connection

4 two conductor bus

5 control unit

6 interface

BT wireless module

C energy storing capacitor

DC direct voltage converter

FD field device

H superordinated unit

M sensor element

1-11. (canceled)

12. A method for assuring operation of a wireless module of a process automation field device having the wireless module and at least one function module,
wherein the field device is supplied with energy by a two conductor bus, and
wherein the wireless module is continuously supplied with energy by the two conductor bus, the method comprising:
activating the wireless module in a test mode in which the wireless module transmits with a maximum transmission power and is supplied further by the two conductor bus continuously with energy, and
adjusting the operation of the at least one function module such that a maximum energy available to the field device is not exceeded.

13. The method as claimed in claim 12,
wherein the wireless module includes no energy storer and is continuously supplied with energy by the two conductor bus.

14. The method as claimed in claim 12, further comprising:
deactivating the test mode by a manual input.

15. The method as claimed in claim 12,
wherein the activating of the test mode is by a button press on the field device, via an interaction with a display of the field device, via a servicing device that is connected with the field device wirelessly or directly by wire, or via a servicing device that is connected with the field device via the two conductor bus.

16. The method as claimed in claim 12, further comprising:
the field device setting an electrical current input of 3.6 mA on the two conductor bus when the wireless module is activated in the test mode.

17. The method as claimed in claim 12, further comprising:
the wireless module transmitting in the test mode with a highest data rate, a maximum power, a maximum range, a maximally widest frequency band, a continuous transmission operation using continuous carrier, and/or a maximum power consuming radiation angle.

18. The method as claimed in claim 12,
wherein a change of the input voltage of the field device, including the supply voltage on the two conductor bus, influences operation of the at least one function module.

19. The method as claimed in claim 12,
wherein the at least one function module consumes at least temporarily more energy than the two conductor bus continuously delivers, and an energy storer supplied with energy by the two conductor bus is associated with the at least one function module.

20. The method as claimed in claims 12, further comprising:
the at least one function module sending the at least one function module's operating parameters matched to the maximum energy available to the field device and/or the at least one function module's maximum possible operating parameters to a display of the field device via a communication via the two conductor bus and/or via the wireless module.

21. The method as claimed in claim 12,
wherein the at least one function module includes a sensor element configured to register a measured variable and to forward values to the wireless module, and
wherein the wireless module is embodied to wirelessly transmit the values to a superordinated unit.

22. The method as claimed in claim 21,
wherein the sensor element is an IFSET or is a sensor element configured to measure a fill level according to the radar-principle, a pH-value, a redox potential, a conductivity, a turbidity or an oxygen content.
